(19) United States
(12) Patent Application Publication
(10) Pub. No.: US 2014/0084842 A1
(43) Pub. Date: Mar. 27, 2014

(54) Energy Saving Solar Device

(71) Applicants: Shawn Wright, St Catherine (JM); Cornette Hylton, St Catherine (JM)

(72) Inventors: Shawn Wright, St Catherine (JM); Cornette Hylton, St Catherine (JM)

(21) Appl. No.: 13/623,956

(22) Filed: Sep. 21, 2012

(51) Int. Cl. H02J 7/35

(52) U.S. Cl. CPC H02J 7/35
USPC 320/101

(57) ABSTRACT

Herein is disclosed an improved device for supplying electrical current to a load from a primary current source. The device includes first and second rechargeable batteries each of which is coupled to both the load and the primary current source by a circuit. The circuit is configured to supply the load by cyclically drawing current directly from the batteries one at a time. During each cycle, the circuit draws current from one of the batteries while simultaneously recharging the other battery which with current from the primary current source. The circuit is configured to switch the drawing and recharging of the batteries at the end of each cycle. The circuit is further configured to set the cycle for a period of several minutes.

### FIELD OF THE INVENTION

The invention relates generally to devices for supplying electrical power to a load using photo voltaic cells.

### BACKGROUND OF THE INVENTION

Photo voltaic cells are often used to provide electrical power to loads which are not coupled to the grid. They are also used to provide electrical energy for the purpose of recharging electric batteries to be used as a backup power source. Loads are occasionally quite constant; however, it is common for loads to draw vastly different currents at different times. A start up process, such as starting a compression pump, often draws very high current initially and then much less current a few seconds later. In order to deliver adequate current to supply a varying load, the photovoltaic array must have sufficient capacity to deliver the high currents which are periodically required by the load. Unlike dynamos powered by gas or diesel engines, photovoltaic cells are not capable of increasing the current they generate in response to increased load. For this reason, solar power systems generally involve a rechargeable battery to deliver the additional current when required, with the photovoltaic cell not only supplying part of the required current, but also recharging the storage battery.

Lithium polymer storage batteries represent the state of the art when it comes to rechargeable storage batteries. In addition to having higher capacity and greater energy densities, these batteries are capable of delivering very high currents. Unfortunately, lithium polymer batteries suffer the disadvantage of suffering damage each time they are discharged significantly. For this reason, the life expectancy of a lithium polymer battery which is periodically discharged is significantly decreased the more the battery is discharged each time. It is therefore desirable to provide a battery circuit which provides continuous current to a load while at the same time preserving the life of the rechargeable batteries used.

### SUMMARY OF THE INVENTION

In accordance with one aspect of the present invention, there is provided an improved device for supplying electrical current to a load from a primary current source. The device includes first and second rechargeable batteries each of which is coupled to both the load and the primary current source by a circuit. The circuit is configured to supply the load by cyclically drawing current directly from the batteries one at a time. During each cycle, the circuit draws current from one of the batteries while simultaneously recharging the other battery which with current from the primary current source. The circuit is configured to switch the drawing and recharging of the batteries at the end of each cycle. The circuit is further configured to set the cycle for a period of several minutes.

In accordance with another aspect of the present invention, there is provided an improved device for supplying electrical current as described above wherein the primary current source consists one or more photovoltaic cells.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

### DESCRIPTION OF THE DRAWINGS

FIG. 1 is a schematic view of a current delivery circuit made in accordance with one aspect of the present invention.

FIG. 2 is a schematic view of a first portion of a current delivery circuit made in accordance with one aspect of the present invention.

FIG. 3 is a schematic view of a second portion of a current delivery circuit made in accordance with one aspect of the present invention.

In the drawings like characters of reference indicate corresponding parts in the different figures.

### DETAILED DESCRIPTION OF THE INVENTION

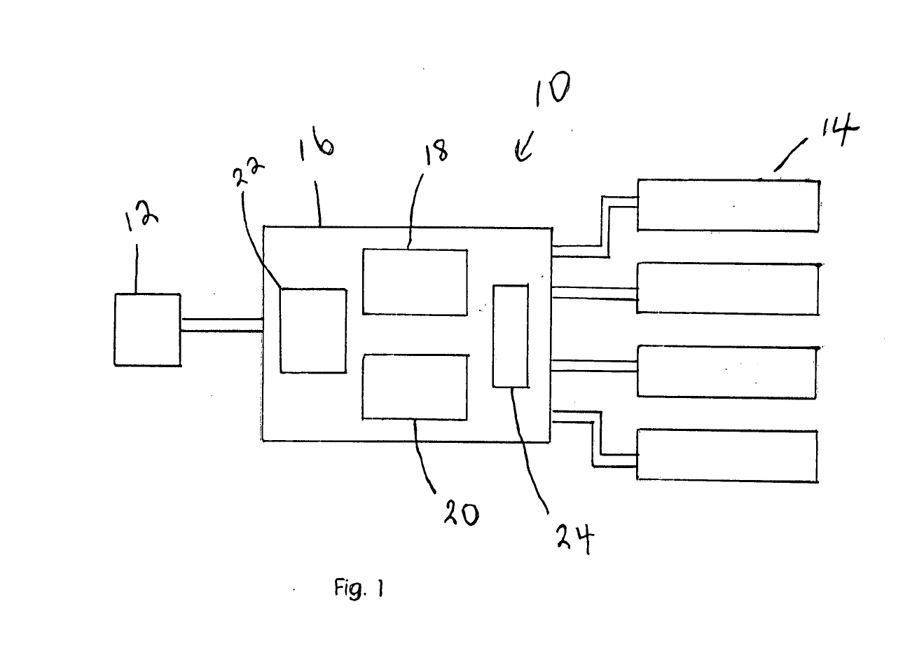

Referring to FIGS. 1, a circuit made in accordance with the present invention is shown generally as item 10 and consists of a load 12 which is to be supplied by a current, ultimately from primary current source 14. Circuit 16 couples load 12 with primary current source 14. Circuit 16 includes rechargeable batteries 18 and 20, relay 22 and timer circuit 24. In circuit 16, relay 22 is coupled to both batteries 18 and 20 and to both the load and to the primary current source. Relay 22 is configured to alternate between two states, a first state wherein current can flow from first battery 18 and load 12 but no current can flow between the load and second battery 20, and a second state wherein current can flow between the load and second battery 20 but no current can flow between first battery 18 and the load. Timer 24 is coupled to relay 22 and is configured to generate a cyclical signal configured to switch relay 22 between its first and second states at the end of each cycle. Circuit 16 is configured such that when one of the batteries is supplying the load with current, the other battery is being recharged by the primary current source. As a result, the batteries are cyclically de-charged (i.e. supplying current), with the time period of each cycle preferably set to approximately five minutes in order to maximize the life of the batteries. The cyclical de-charging of the batteries can be accomplished in a variety of ways. Relay 22 can be a multi phase relay configured such that when it opens the circuit between one of the batteries and the load it simultaneously closes the circuit between the other battery and the load. Alternatively, additional relays could be interposed between each of the batteries and the primary current source, with the additional relays being triggered either by the timer circuit or by relay 22. Circuit 16 could also include additional elements to better recharge the batteries and to better supply the load with current. For example, if the load requires an alternating current, one or more inverters could be interposed between the batteries and the load. Also, to ensure proper recharging of the batteries, a battery charger could be interposed between the primary current source and the rechargeable batteries.

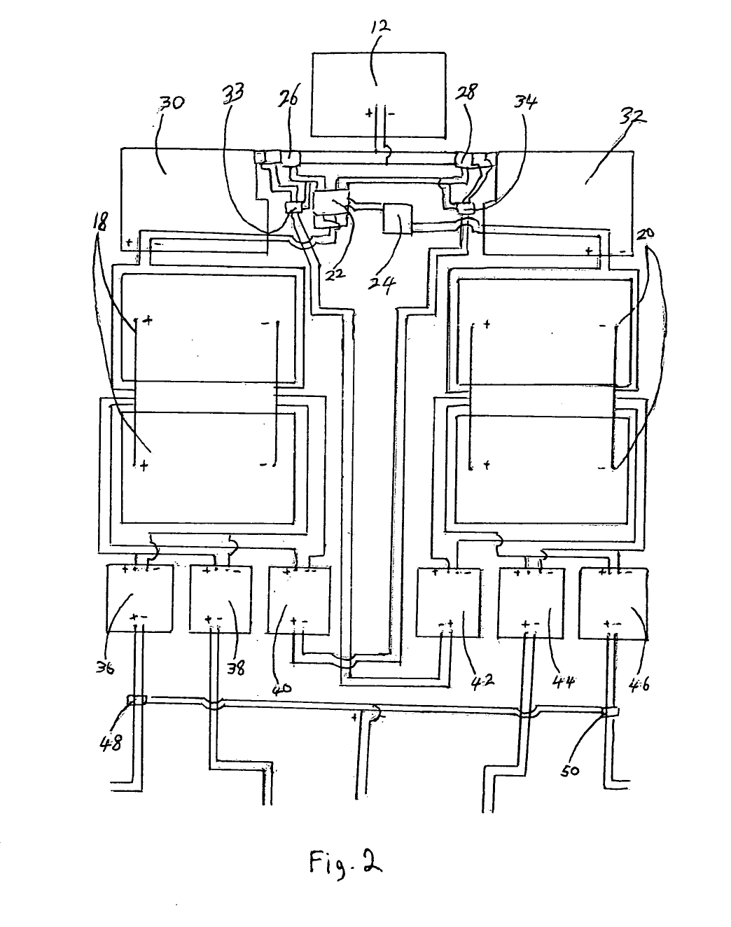

Referring now to FIG. 2, as mentioned above, circuit 16 may include a plurality of additional relays and other elements to facilitate the supply of current to the load and the recharging of the batteries. In addition to relay 22 and timer 24, inverters 30 and 32 can be provided which couple batteries 18 and 20, respectively, with load 12 to provide load 12 with an AC current. Contactors 26 and 28 couple inverters 30 and 32 to load 12 and act to open and close the circuit between the inverters and the load in a cyclical fashion. Each of contactors 26 and 28 have a “closed” state wherein the circuit between the load and the inverter coupled to that contactor is closed (and current is free to flow) and an “open” state wherein said circuit is opened and current cannot flow. Contactors 26 and 28 are coupled to relay 22 which controls the state that the contactors are in. In particular, relay 22 is wired to contactors 26 and 28 such that the relay places one of the contactors in its open state while it simultaneously places the other contactor in its closed state. As mentioned previously, relay 22 itself operates between a first and second state and is controlled by a timer circuit 24. Timer circuit 24 is any standard electronic timer capable of generating a cyclical on/off signal having a preselected time period. Preferably that time period is set to about five minutes. Relay 22 is supplied with current from one of the batteries (in this case, battery 18) which uses the current to operate contactors 26 and 28. Relay 22 thereby controls the flow of current between the load and batteries 18 and 20 by controlling the operation of contactors 26 and 28. Since the signal produced by timer circuit 24 may not be sufficient to operate contactors 26 and 28, the signal is used to control relay 22, which in turn controls contactors 26 and 28.

Batteries 18 and 20 are coupled to battery chargers which are in turn coupled to one or more primary current sources. Batteries 18 can be charged by chargers 36, 38 and 40 depending on the availability of grid current and solar power. Likewise, batteries 20 can be charged by chargers 42, 44 and 46 also depending on the availability of grid power and solar power. Chargers 36 and 46 are battery chargers which are coupled to battery banks 18 and 20, respectively. Chargers 36 and 46 are preferably plugged into the local grid as their primary current source. Chargers 36 and 46 are coupled to relays 48 and 50, respectively, which in turn are coupled to the solar cells so that when solar energy is available in sufficient current, relays 48 and 50 switches off the grid current to charger 36 and 46, respectively, so that the battery banks can be charged from the solar cells. Charger 38 is coupled to the solar cells and controls the charging of battery bank 18 from the solar cells. Likewise, charger 44 is coupled to the solar cells and controls the charging of battery bank 20 from the solar cells. Charger 40 is coupled to battery bank 18 and to inverter 32 via relay 34. Relay 34 is controlled by relay 22 such that the relay controls the flow of current from inverter 32 to charger 40 depending on the state of relay 22. When relay 22 closes the circuit, current from inverter 32 powers charger 40. This in turn recharges battery bank 18. Likewise, charger 42 is coupled to battery bank 20 and to inverter 30 via relay 33. Relay 33 is controlled by relay 22 such that the relay controls the flow of current from inverter 30 to charger 42 depending on the state of relay 22. When relay 22 closes the circuit, current from inverter 30 powers charger 42 which in turn recharges battery bank 20.

It will be appreciated that the relays, contactors, inverters and battery charges are all standard components that are readily available in the marketplace. The size and rating of these components is governed by the desired currents to be delivered. Table 1 below lists an example of the sort of components which could be used to build a system; however, any equivalent component from other suppliers can be used.

TABLE 1
Example List of Components

| Component | Description |
|---|---|
| Inverter 30 & 32 | 3500 watt Outback ™, 24 v DC 60 Hz |
| Timer 24 | Multifunction timer control, 24 v DC input |
| Contactor 26 & 28 | 3 Pole Contactor 50 amps |
| Relays 33 & 34 | Square D ™ 2 pole normally open, 2 pole normally |
| | closed, 24 V DC |
| Relays 48 & 50 | Square D ™ relay 30 amps, all poles normally open |
| Chargers 36 & 46 | 24 v 12 amp battery charger, Charge Master ™ |
| | Model # 24/12-3 |
| Chargers 38 & 44 | Xantrex ™ C-40 Charge controller 24 v-DC |
| Chargers 40 & 42 | 24 v-12 amp battery charger, Charge Master ™ |
| | Model # 24/12-3 |
| Solar Cells 52 & 54 | BP ™ Solar panels, 120 Watt 12 v |

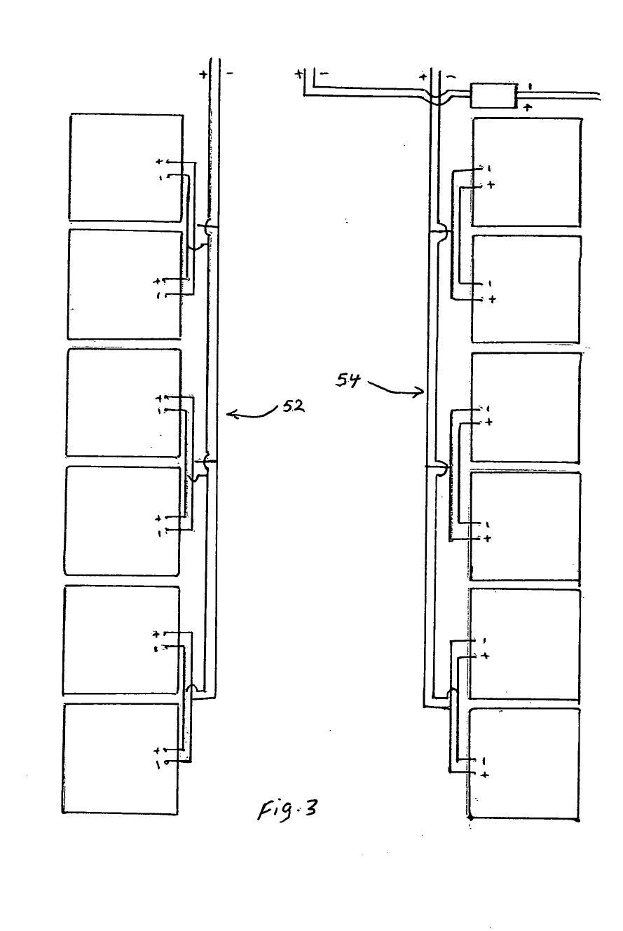

Referring now to FIG. 3, the photovoltaic cells used to generate the primary current for the system, shown generally as solar cell banks 52 and 54, are made up of a plurality of standard photovoltaic cells. For example, each bank of solar cells could consist of six 12 volt lamp peak photovoltaic cells; however, the exact number and type of photovoltaic cell would be determined by the needs of the user.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims.

Therefore, what is claimed is:

1. A device for providing electrical current to a load from at least one solar cell, the device comprising:
a. A first and second rechargeable batteries, each of the batteries being coupled to both the load and the solar cell by a circuit;
b. The circuit configured to supply the load by cyclically drawing current directly from the batteries one at a time, the circuit being configured to draw current from one battery for a period of time while simultaneously recharging the other battery from current supplied by the solar cell for said period of time, the drawing of the batteries being switched at the end of each cycle, the period of time lasting for several minutes.

2. The device defined in claim 1 wherein the circuit comprises a first relay for alternately cycling each battery between drawing and recharging and a timer coupled to the relay for controlling the first relay.

3. The device of claim 2 wherein the circuit comprises first and second contactors coupled between the first and second batteries and the load, respectively, the first and second contactors being coupled to the first relay so that the first relay controls the opening and closing of the first and second contactors.

4. The device of claim 3 wherein the circuit further comprises first and second inverters, the first inverter being coupled between the first contactor and the first battery and the second inverter being coupled between the second contactor and the second battery.

5. The device of claim 3 wherein the circuit further comprises a second relay coupled between the first battery and the solar cell and a third relay coupled between the second battery and the solar cell, the second and third relays being coupled to the first relay, the circuit being configured such that the first and second contactors are always in opposite states of either open and closed, the circuit being further configured such that the second relay and the first contactor are always in opposite states of either open or closed, and wherein the circuit is further configured such that the third relay and the second contactor are always in opposite states of either open or closed.

6. The device of claim 1 wherein the circuit comprises first and second contactors operatively coupled between the load and the first and second batteries, respectively, the circuit further comprising a first and second relay operatively coupled between the solar cell and the first and second batteries, respectively, each of the relays and contactors operable between open and closed states, the relays and contactors each being operatively coupled to a timer, the circuit configured such that the first and second contactors and the first and second relays are always in opposite states, the circuit being further configured such that the first contactor and the first relay are always in opposite states, the circuit being further configured such that the second contactor and the second relay are always in opposite states, the circuit being further configured such that the timer circuit reverses the states of each of the relays and contactors each cycle.

7. A device for providing electrical current to a load from a primary current source, the device comprising:
a. A first and second rechargeable batteries, each of the batteries being coupled to both the load and the primary current source by a circuit;
b. The circuit configured to supply the load by cyclically drawing current directly from the batteries one at a time, the circuit being configured to draw current from one battery for a period of time while simultaneously recharging the other battery from the primary current source for said period of time, the drawing of the batteries being switched at the end of each cycle, the period of time lasting for several minutes.
